(19) United States
(12) Patent Application Publication
(10) Pub. No.: US 2008/0301680 A1
(43) Pub. Date: Dec. 4, 2008

(54) INFORMATION PROCESSING APPARATUS

(75) Inventor: Yasuhiko ABE, Saitama-Ken (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/128,732

(22) Filed: May 29, 2008

(30) Foreign Application Priority Data
May 31, 2007 (JP) P2007-146008

(51) Int. Cl. G06F 9/46

(52) U.S. Cl. 718/100

(57) ABSTRACT

To realize a situation that while the number of inspection performed on a stack used as a variable storage area is reduced, a use efficiency of a CPU is improved and the stack used as the variable storage area is preferably inspected. In a cellar phone according to an embodiment of the present invention, a main control section controls an execution of an intermittent operation in the cellar phone, when the cellar phone returns from the intermittent operation in accordance with the control, a timer for a stack inspection is set in a first state, and each time the timer for the stack inspection times out, the stack inspection is executed.

### BACKGROUND OF THE INVENTION

1. Field of the Invention

The present invention relates to an information processing apparatus such as a cellar phone. In particular, one invention relates to an information processing apparatus in which a stack used as a variable storage area can be inspected.

2. Description of the Related Art

In recent years, a cellar phone has a CPU. This CPU (Central Processing Unit) reads out various application programs previously stored in a ROM (Read Only Memory) or a storage section onto a RAM (Random Access Memory) for executing the programs to thereby perform various processings.

In general, a thread (an execution unit of a program) executed by a CPU temporarily uses a memory, which is referred to as stack, as a variable storage area. In addition, this variable storage area stores a return address of a program each time a subroutine is called. If the variable storage area is damaged while some data enters this variable storage area, the thread may run out of control.

In the information processing apparatus such as the cellar phone in operation, it is necessary to promptly detect the damage of this variable storage area. For example, as a method of detecting the damage in the variable storage area, there is known a stack inspection method of detecting the carnage in the variable storage area by comparing as to whether generic data included in an upper limit value of the stack used as the variable storage area is damaged. When the damage in the variable storage area is detected, the stack is to be reset (for example, refer to Japanese Unexamined Patent Application Publication No. 8-77004).

However, when this stack inspection method is used, a CPU resource is largely consumed upon the detection. If the stack inspection is frequently executed so as to enable the detection of the damage in the variable storage area, such a problem occurs that an information processing efficiency may be degraded.

### SUMMARY OF THE INVENTION

Accordingly, the present invention has been made in view of the above-mentioned circumstances, it is an object of the present invention to provide an information processing apparatus in which while the number of inspection executed on a stack used as a variable storage area is reduced, a use efficiency of a CPU is improved, the stack used as the variable storage area is preferably inspected, and a critical situation such as a content damage can be avoided.

According to an aspect of the present invention, in order to solve the above-mentioned problem, there is provided an information processing apparatus, including: an intermittent operation execution control unit configured to control an execution of an intermittent operation in the information processing apparatus; a timer setting unit configured to set a timer for a stack inspection in a first state if the information processing apparatus returns from the intermittent operation in accordance with a control of the intermittent operation execution control unit; and a stack inspection execution unit configured to execute the stack inspection each time the timer for the stack inspection set by the timer setting unit times out.

In the information processing apparatus according to the aspect of the present invention, the execution of the intermittent operation in the information processing apparatus is controlled, returning from the intermittent operation in the information processing apparatus in accordance with the control, the timer for the stack inspection is set in the first state, and each time the set timer for the stack inspection times out, the stack inspection is executed.

According to the aspect of the present invention, while the number of inspection performed on the stack used as the variable storage area is reduced, the stack used as the variable storage area is preferably inspected, and it is possible to avoid the critical situation such as a content damage.

### BRIEF DESCRIPTION OF THE DRAWINGS

FIGS. 1A and 1B are external configuration views of a cellar phone which can be applied to an information processing apparatus according to an embodiment of the present invention;

FIGS. 2A and 2B are other external configuration views of the cellar phone which can be applied to the information processing apparatus according to the embodiment of the present invention;

FIG. 3 is a block diagram of an internal configuration of the cellar phone which can be applied to the information processing apparatus according to the embodiment of the present invention;

FIG. 4 is a flowchart for describing a stack inspection processing in the cellar phone of FIG. 3; and

FIG. 5 is a flowchart for describing another stack inspection processing in the cellar phone or FIG. 3.

### DESCRIPTION OF THE PREFERRED EMBODIMENTS

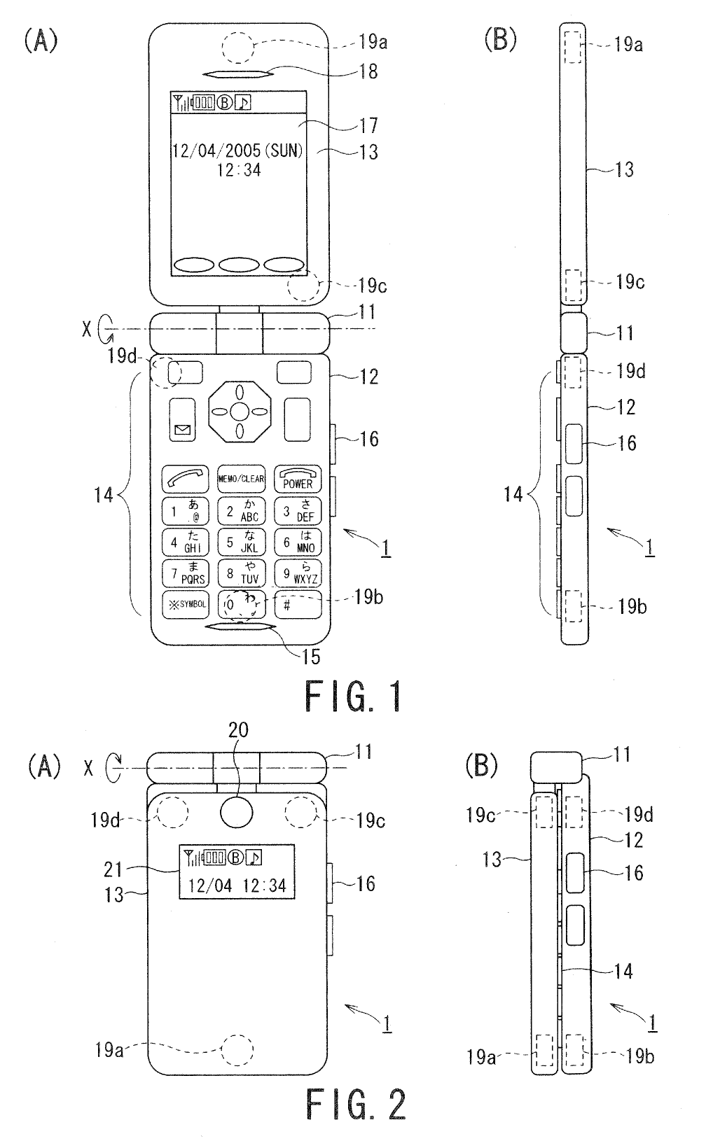

Hereinafter, embodiments of the present invention will be described with reference to the Drawings. FIGS. 1A and 1B are external configuration views of a cellar phone 1 applicable to an information processing apparatus according to an embodiment of the present invention. It should be noted that FIG. 1A is an external configuration of the cellar phone 1 opened at about 180 degrees as viewed from the front, and FIG. 1B is an external configuration of the opened cellar phone 1 as viewed from the side.

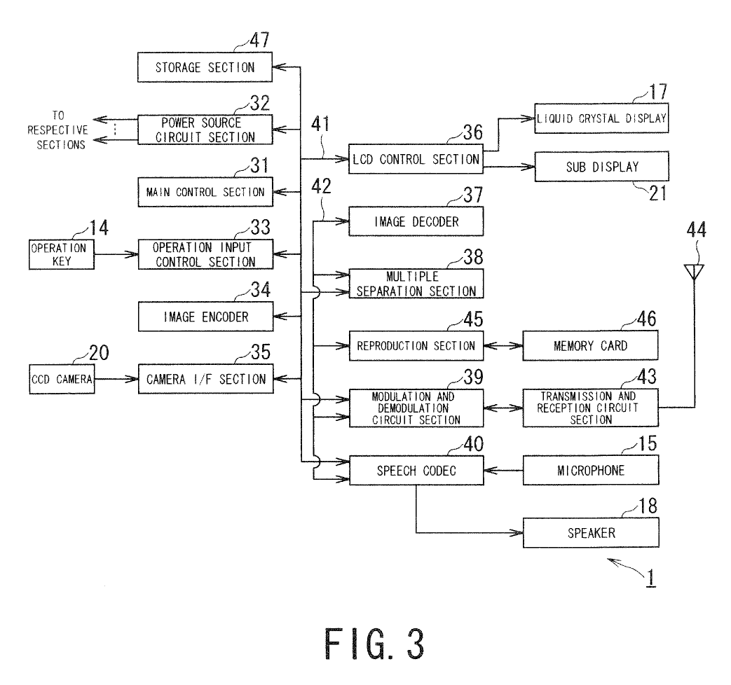

As illustrated in FIGS. 1A and 1B, in the cellar phone 1, a first casing 12 and a second casing 13 are coupled through a hinge with a hinge part 11 at a center. The cellar phone 1 is formed so as to be foldable via the hinge part 11 in an arrow X direction. At a predetermined position inside the cellar phone 1, an antenna for transmission and reception (an antenna 44 of FIG. 3 which will be described later) is provided. Via the accommodated antenna, radio waves are transmitted and received between a base station (not shown).

On a surface of the first casing 12, operation keys 14 such as numeral keys “0” to “9”, an outgoing call key, a redial key, a call end/power key, a clear key, and an electronic mail key are provided. By using the operation keys, it is possible to input various instructions.

In an upper part of the first casing 12, an arrow key and a confirmation key are provided as the operation keys. As a user operates the arrow key in up, down, left, and right directions, an assigned cursor can be moved in the up, down, left, and right directions. To be more specific, various operations such as a scroll operation of a telephone directory list or an electronic mail displayed on a liquid crystal display 17 provided to the second casing 13, a page roll up operation of a simplified home page, and an image feed operation are executed.

Also, by pressing the confirmation key, various functions can be confirmed. For example, in accordance with the operation of the arrow key by the user, when a predetermined telephone number is selected from among a plurality of telephone numbers in the telephone directory list displayed on the liquid crystal display 17 and the confirmation key is pressed in an inner side of the first casing 12, the first casing 12 confirms the selected telephone number and performs a calling processing.

Furthermore, the first casing 12 is provided with an electronic mail key on the heft side of the arrow key and the confirmation key. When the electronic mail key is pressed in the inner side of the first casing 12, it is possible to call a mail transmitting and receiving function. A browser key is provided next to the arrow key and the confirmation key on the right side. When the browser key is pressed in the inner side of the first casing 12, it is possible to view data of a web page. Also, the first casing 12 is provided with a microphone 15 at a lower part of the operation keys. Through the microphone 15, a voice of the user upon the conversation is collected. In addition, the first casing 12 is provided with a side key 16 for operating the cellar phone 1.

On the other hand, the second casing 13 is provided with the liquid crystal display 17 (main display) on the front. On the liquid crystal display 17, it is possible to display, in addition to a reception status of the electric waves, a battery remaining amount, a contact name and a telephone number registered in the telephone directory, and a transmission history, a content of an electronic mail, a simple home page, an image captured by a CCD (Charge Coupled Device) camera (a CCD camera 20 of FIG. 2A which will be described later), a content received from an external content server (not shown), and a content stored in a memory card (a memory card 46 of FIG. 3 which will be described later). Also, a speaker 18 is provided at a predetermined position on the upper side of the liquid crystal display 17. With this configuration, the user can make a telephone call.

FIGS. 2A and 2B illustrate other external configurations of the cellar phone 1 applicable as the information processing apparatus according to the embodiment of the present invention. A state of the cellar phone 1 of FIGS. 2A and 2B corresponds to a state obtained by turning the cellar phone 1 of FIGS. 1A and 1B in the arrow X direction. It should be noted that FIG. 2A illustrates an external configuration when the cellar phone 1 is closed as viewed from the front, and FIG. 2B illustrates an external configuration when the cellar phone 1 is closed as viewed from the side.

The CCD camera 20 is provided in an upper side of the second casing 13, and with this configuration, a predetermined photographing target can be imaged. A sub display 21 is provided in a lower side of the CCD camera 20. An antenna pictograph indicating a level of a current antenna sensitivity, a battery pictograph indicating a current battery remaining amount of the cellar phone 1, a current time, and the like are displayed on the sub display 21.

FIG. 3 illustrates an internal configuration of the cellar phone 1 applicable as the information processing apparatus according to the embodiment of the present invention. As illustrated in FIG. 3, the cellar phone 1 is configured in such a manner that a power source circuit section 32, an operation input control section 33, an image encoder 34, a camera interface section 35, a LCD (Liquid Crystal Display) control section 36, a multiple separation section 38, a modulation and demodulation circuit section 39, an speech codec 40, and a storage section 47 are mutually connected via a main bus 41 with respect to a main control section 31 for controlling the respective sections of the first casing 12 and the second casing 13, and also the image encoder 34, an image decoder 37, the multiple separation section 38, the modulation and demodulation circuit section 39, the speech codec 40, and a recording and reproduction section 45 are mutually connected via a synchronous bus 42.

The main control section 31 is composed of a CPU (Central Processing unit), a ROM (Read Only Memory), and a RAM (Random Access Memory). The CPU executes various processings in accordance with the programs stored in the ROM or various application programs loaded from the storage section 47 onto the RAM, and also generates various control signals to be supplied to the respective sections, thus controlling the cellar phone 1 in an overall manner. The RAM appropriately stores data necessary for the CPU to execute the various processings. It should be noted that the main control section 31 accommodates a timer for accurately keeping the current date and time.

On the basis of the control of the main control section 31, the cellular phone 1 converts the speech signal collected by the microphone 15 in a telephone call mode into a digital signal by the speech codec 40 to be compressed. The cellar phone 1 subjects the compressed digital signal to a spread spectrum processing in the modulation and demodulation circuit section 39 and a digital/analog conversion processing and a frequency conversion processing in a transmission and reception circuit section 43. After that, the cellar phone 1 transmits the thus obtained signal via the antenna 44.

Also, the cellar phone 1 amplifies the reception signal received by the antenna 44 in the audio conversation mode. The cellar phone 1 subjects the amplified signal to a frequency conversion processing and an analog/digital conversion processing and a dispread spectrum processing in the modulation and demodulation circuit section 39. The cellar phone 1 subjects the signal to expansion in the speech codec 40 and converts the signal into an analog speech signal. After that, the cellar phone 1 outputs the converted analog speech signal via the speaker 18.

Furthermore, in a case where an electronic mail is transmitted in a data communication mode, the cellar phone transmits text data of the electronic mail input through the operation of the operation keys via the operation input control section 33 to the main control section 31. The main control section 31 subjects the text data to the spread spectrum processing in the modulation and demodulation circuit section 39 and to the digital/analog conversion processing and the frequency conversion processing in the transmission and reception circuit section 43. After that, the cellar phone 1 transmits the thus obtained signal via the antenna 44 to a base station (not shown).

In contrast to this, in a case where an electronic mail is received in the data communication mode, the cellar phone 1 subjects the reception signal received from the base station (not shown) via the antenna 44 to the dispread spectrum processing in the modulation and demodulation circuit section 39. After that, the cellar phone 1 displays the data as the electronic mail via the LCD control section 36 on the liquid crystal display 17.

In a case where an image signal is transmitted in the data communication mode, the cellar phone 1 supplies an signal of the image captured by the CCD camera 20 via the camera interface section 35 to the image encoder 34.

The image encoder 34 converts the image signal supplied from the CCD camera 20 into an encoded image signal by compression-encoding the signal in a predetermined encoding method such as MPEG (Moving Picture Experts Group)4 standard and transmits the converted encoded image signal to the multiple separation section 38. At this time, simultaneously, the cellar phone 1 transmits the speech collected by the microphone 15 during the photography with the CCD camera 20 via the speech codec 40 as a digital speech signal to the multiple separation section 38.

The multiple separation section 38 multiplexes the encoded image signal supplied from the image encoder 34 and the speech signal supplied from the speech codec 40 in a predetermined method and subjects the multiplexed signal obtained to the spread spectrum processing in the modulation and demodulation circuit section 39. The multiple separation section 38 subjects the signal to the digital/analog conversion processing and the frequency conversion processing in the transmission and reception circuit section 43 and thereafter transmits the signal via the antenna 44. In contrast to this, in the cellar phone 1, in the data communication mode, it is possible to receive data of a Web page.

In addition, in a case where data of a moving image file which is linked to a Web page or the like, for example, in the data communication mode, the cellar phone 1 subjects the reception signal received via the antenna 44 from the base station (not shown) to the dispread spectrum processing in the modulation and demodulation circuit section 39 and transmits the multiplexed signal to the multiple separation section 38.

The multiple separation section 38 separates the multiplexed signal into the encoded image signal and the audio signal. The multiple separation section 38 supplies the encoded image signal via the synchronous bus 42 to the image decoder 37 and also supplies the audio signal to the speech codec 40. The image decoder 37 generates a reproduction moving image signal by decoding the encoded image signal in a decoding format corresponding to the predetermined encoding method such as MPEG4 standard and supplies the thus generated reproduction moving image signal via the LCD control section 36 to the liquid crystal display 17. With this configuration, the moving image data included in the moving image file which is linked to the Web page or the like, for example, is displayed. At this time, simultaneously, the speech codec 40 converts the audio signal into an analog audio signal, and thereafter supplies the analog audio signal to the speaker 18. With this configuration, the audio signal included in the moving picture file which is linked to the Web page is reproduced.

The storage section 47 is configured, for example, of a flash memory element which is a non-volatile memory in which writing and deletion can be electrically performed, a HDD (Hard Disc Drive), or the like. The storage section 47 stores the various application programs executed by the CPU of the main control section 31 and various data groups.

Incidentally, in the information processing apparatus such as the cellar phone in operation, when the various applications are executed by the CPU, a thread (an execution unit of a program) executed by a CPU temporarily uses a memory referred to as stack as a variable storage area. In addition, this variable storage area stores a return address of a program each time a subroutine is called. Then, when the CPU execute the application, it is necessary to promptly detect the damage of this variable storage area. For example, as a method of detecting the damage in the variable storage area, a stack inspection method of detecting the damage in the variable storage area by comparing as to whether generic data included in an upper limit value of the stack used as the variable storage area is known. When the damage in the variable storage area is detected, the stack is reset.

However, when this stack inspection method is used, a CPU resource is largely consumed upon the detection. If the stack inspection is frequently executed so as to enable the detection of the damage in the variable storage area, an information processing efficiency becomes degraded.

In a complicated processing, as a processing time becomes long in general. For example, the damage in the variable storage area includes a memory damage due to a program error, a stack overflow in which a stack consumption exceeds a designed value. Thus damage in the variable storage area is like to be caused in particular, in a program executing a complicated processing. Herein, in the cellar phone 1, a minimum processing necessary for a network synchronization is only operated during an intermittent operation, and a complicated processing by applications of the GUI (Graphical User Interface) is not operated.

In view of the above, the stack inspection is not executed during the intermittent operation in which a complicated processing is not operated. At a moment returning from the intermittent operation when a complicated processing is likely to be operated, it is determined whether a processing other than a network synchronization processing is operated. In a case where it is determined that the processing other than the network synchronization processing is operated, after a stack inspection timer is turned ON, when this stack inspection timer times out, the stack used as the variable storage area can be inspected. With this configuration, while the number of inspection performed on the stack used as the variable storage area is reduced, the use efficiency of the CPU is improved, and the stack used as the variable storage area can be appropriately inspected. Hereinafter a description will be given of a stack inspection processing by using this method.

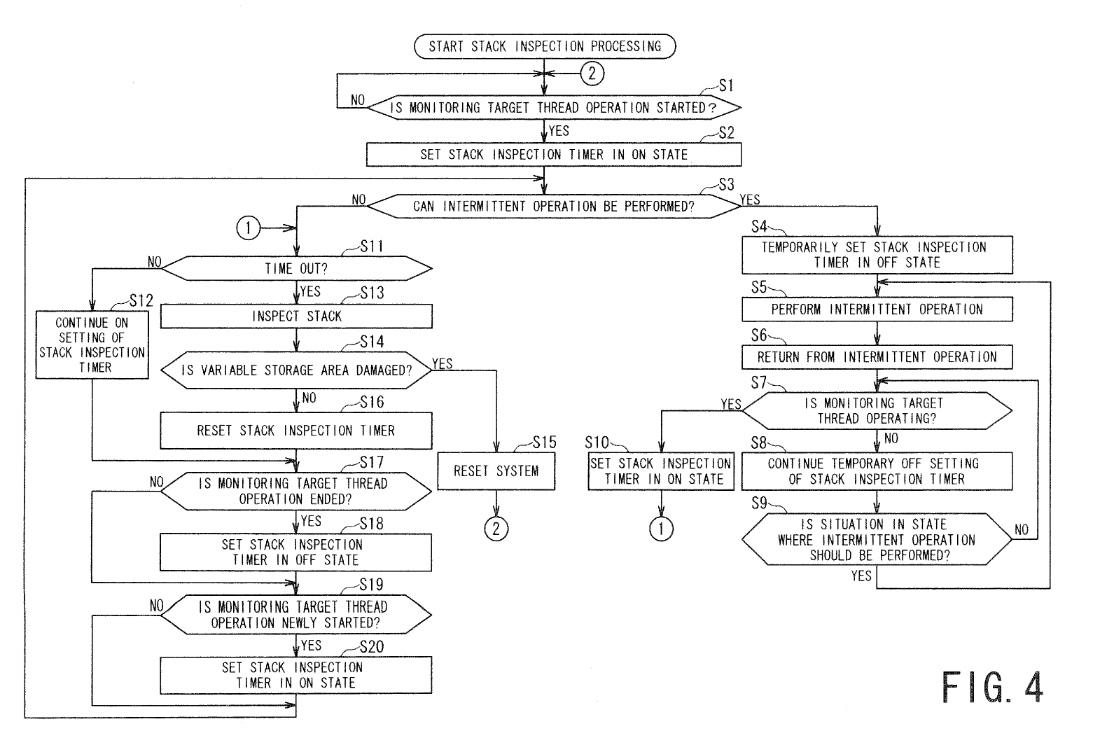

With reference to a flowchart of FIG. 4, the stack inspection processing in the cellar phone 1 of FIG. 3 will be described. This stack inspection processing is started in such a case that a power source of the cellar phone 1 is turned ON as the user operates the call end/power source key, for example, among the operation keys (for example, a long press lasting for one second or longer).

In step S1, the CPU of the main control section 31 determines whether in a case where a transfer of events for a plurality of threads is controlled, among the plurality of threads, a monitoring target thread whose operation can be monitored receives an event and the operation of the monitoring target thread is started, and stands by until it is determined that the operation of the monitoring target, thread is started.

In step S1, in a case where it is determined that the operation of the monitoring target thread is started, when the user operates the call end/power source key of the operation keys and the power source of the cellar phone 1 is turned ON, the CPU of the main control section 31 uses the built-in timer in step S2 to set the stack inspection timer in an ON state. In step S3, while the CPU of the main control section 31 executes (or is executing) a particular program (for example, a program related to sleep), it is determined whether the current situation is in a state where the intermittent operation should be performed (or at a timing to transit to the intermittent operation). For example, when a back light (display) of the liquid crystal display 17 in the cellar phone 1 is turned OFF, by activating the particular program (for example, the program related to the sleep), it is determined that the current situation is in the state where the intermittent operation should be performed in the cellar phone 1.

In step S3, by executing the particular program (for example, the program related to the sleep), when it is determined that the current situation is in the state where the intermittent operation should be performed in the cellar phone 1, the CPU of the main control section 31 sets the stack inspection timer which is currently set in the ON state and keeps the time to be in an OFF state temporarily in step S4. In step S5, the CPU of the main control section 31 starts the intermittent operation in the cellar phone 1 and the CPU of the main control section 31 is put into a sleeping state. In step S6, the cellar phone 1 returns from the intermittent operation in a predetermined case. It should be noted that the “intermittent operation” refers to a state in which the CPU of the main control section 31 is not basically operated (in step S4 ), and the CPU is operated at a fixed time for performing a necessary minimum processing such as the determination as to whether the cellar phone 1 receives an audio incoming call, the network synchronization, or the determination as to whether there is a mail reception (in step S6).

In step S7, when the cellar phone 1 returns from the intermittent operation, the CPU of the main control section 31 is transited from the sleeping state to a normal state (a CPU operation state). In a case where the transfer of events for a plurality of threads is controlled, among the plurality of existing threads, it is determined whether the monitoring target thread whose operation can be monitored receives an event. In other words, it is determined whether the thread in which the stack inspection can be executed is operated. Of course, even in a case where the transfer of events for a plurality of threads is controlled, it is determined whether the thread in which the stack inspection can be executed is operated.

In step S7, in a case where it is determined that among the plurality of existing threads, the monitoring target thread whose operation can be monitored does not receive an event and the operation of the monitoring target thread is not started, the CPU of the main control section 31 continues the temporary OFF setting of the timer for the stack inspection in step S8. In step S9, as the CPU of the main control section 31 further executes (or is executing) the particular program (for example, the program related to the sleep), it is determined whether the current situation is in the state where the intermittent operation should be performed (or at a timing to transit to the intermittent operation). The determination processing as to whether the current situation is in the state where the intermittent operation should be performed during this period is similar to the processing in step S3, and a description thereof will be omitted to avoid the repetition.

In step S9, in a case where it is determined that the current situation is not in the state where the intermittent operation should be performed (or the timing to transit to the intermittent operation), the processing is returned to step S7, and the processing in step S7 and subsequent steps is repeatedly executed. That is, even in a case where the current situation is not in the state where the intermittent operation should be performed and also the monitoring target thread is not operated, the temporary OFF setting of the stack inspection timer is continued.

On the other hand, in step S9, in a case where it is determined that the current situation is in the state where the intermittent operation should be performed (or the timing to transit to the intermittent operation), the processing is returned to step S5, and the processing in step S5 and subsequent steps is repeatedly executed. That is, in a case where the current situation is in the state where the intermittent operation should be performed and also the monitoring target thread is not operated, the temporary OFF setting of the stack inspection timer is continued and also the intermittent operation is repeatedly performed.

With this configuration, in a case where it is determined that among the plurality of existing threads, the monitoring target thread whose operation can be monitored does not receive an event and the operation of the monitoring target thread is not started (that is, in a case where it is determined that the thread in which the stack inspection can be executed is not operated), as there is no meaning to carry out the stack inspection from the beginning, it is possible to avoid the execution of the stack inspection. Therefore, the inefficient stack inspection can be omitted.

On the other hand, in step S7, in a case where it is determined that among the plurality of existing threads, the monitoring target thread whose operation can be monitored receives an event and is operated, the CPU of the main control section 31 sets the timer for the stack inspection (for example, two to three seconds, five seconds, etc.) to be switched from the OFF state to the ON state in step S10. After that, a time keeping processing of the timer for the stack inspection is started. In step S11, the CPU of the main control section 31 determines, as the time keeping processing of the timer for the stack inspection is advanced, whether the timer for the stack inspection (for example, two to three seconds, five seconds, etc.) times out.

In step S11, in a case where it is determined that the timer for the stack inspection (for example, two to three seconds, five seconds, etc.) does not yet time cut, the CPU of the main control section 31 continues the ON setting (timer count) of the timer for the stack inspection in step S10. After that, the processing is advanced to step S17. That is, in step S2, it is determined again whether the current situation is in the state where the intermittent operation should be performed. In a case where it is determined that the current situation is not in the state where the intermittent operation should be performed in the cellar phone 1, the processing is advanced to step S9, and the processing in step S9 and subsequent steps is repeatedly executed. With this configuration, until the stack inspection timer times out, the time keeping processing is performed.

In step S11, in a case where it is determined that the timer for the stack inspection (for example, two to three seconds, five seconds, etc.) times out, the CPU of the main control section 31 executes the stack inspection in step S13. As described above, for example, by comparing whether the generic data included in the upper value of the stack used as the variable storage area is damaged, it is detected that the variable storage area is damaged. Of course, the stack inspection may also be executed by using a method other than the above.

In step S14, the CPU of the main control section 31 determines, as the result of the stack inspection, whether the variable storage area is damaged while the stack used as the variable storage area involves an irregularity. In step S14, in a case where it is determined that the variable storage area is damaged while the stack used as the variable storage area involves an irregularity, the CPU of the main control section 31 restarts the entire system operated by the CPU in step S16 (into a reboot state). After that, the processing is advanced to step S1, and the processing in step S1 and subsequent steps is repeatedly executed.

On the other hand, in step S14, in a case where it is determined that the variable storage area is not damaged while the stack used as the variable storage area does not involve an irregularity, the CPU of the main control section 31 resets the stack inspection timer in step S15 (that is, the ON state of the stack inspection timer is continued). After that, the time keeping processing of the stack inspection timer is started again.

Next, in step S17, the CPU of the main control section 31 determines whether in a case where the transfer of events for a plurality of threads is controlled, among the plurality of existing threads, the operation of the monitoring target thread in which the operation has been started is ended. In other words, it is determined whether the operation of the thread in which the stack inspection can be executed is ended. In step S17, in a case where it is determined that the operation of the monitoring target thread in which the operation has been started is ended, the main control section 31 temporarily sets the stack inspection timer, which is currently set in the ON state, in the OFF state in step S18.

On the other hand, in step S17, in a case where it is determined that the operation of the monitoring target thread in which the operation has been started is not ended, the processing in step S18 is skipped. With this configuration, the stack inspection timer, which is currently set in the ON state, is not set in the OFF state, and the ON setting of the stack inspection timer is continued. In step S19, the CPU of the main control section 31 determines whether in a case where the transfer of events for a plurality of threads is controlled, among the plurality of existing threads, the monitoring target thread whose operation can be monitored receives an event and the operation of the monitoring target thread is newly started.

In step S19, in a case where it is determined that the operation of the monitoring target thread is newly started, the CPU of the main control section 31 uses the built-in timer to set the stack inspection timer to be switched from the OFF state to the ON state in step S20. With this configuration, thereafter, the time keeping processing of the timer for the stack inspection is started. On the other hand, in step S19, in a case where it is determined that the operation of the monitoring target thread is not newly started, the processing in step S20 is skipped. After that, the processing is returned to step S3, and the processing in step S3 and subsequent steps is repeatedly executed.

With this configuration, until it is determined that the current situation is in the state where the intermittent operation should be performed in the cellar phone 1, each time the operation of the monitoring target thread is newly started, the stack inspection timer is set in the ON state. Each time a predetermined time (for example, two to three seconds, five seconds, etc.) elapses on the basis of the stack inspection timer (each time the stack inspection timer times out), the stack inspection processing is repeatedly executed.

According to the embodiment of the present invention, the execution of the intermittent operation is controlled in the cellar phone 1. In accordance with this control, when the cellar phone 1 returns from the intermittent operation, the timer for the stack inspection is set in the ON state (hereinafter, in this specification, the timer ON state is defined as “first state” and the timer OFF state is defined as “second state”). Each time the set stack inspection timer times out, the stack inspection can be executed.

Then, as the result of the stack inspection, it is determined whether the variable storage area is damaged while the stack used as the variable storage area involves an irregularity, and in a case where it is determined that the variable storage area is damaged while the stack used as the variable storage area involves an irregularity, the entire system operated by the CPU is restarted. On the other hand, in a case where it is determined that the variable storage area is not damaged while the stack used as the variable storage area does not involve an irregularity, the stack inspection timer is reset.

With this configuration, while the number of inspection performed on the stack used as the variable storage area is reduced, the use efficiency of the CPU is improved, the stack used as the variable storage area can be inspected in a necessary minimum manner, and also even when there is a problem, the problem is detected in an initial stage, and it is possible to prevent the situation from being transited to a critical situation in which the content is damaged, etc.

Incidentally, in a case where it is determined that after the stack inspection timer is once set in the ON state, the time keeping processing of the stack inspection timer is advanced and a new monitoring target thread is operated before the time out, such a situation can also be considered that the stack inspection timer does not time out. For example, in a case where a monitoring target thread A is operated, when monitoring target threads B, C, and D then sequentially start operating, if the stack inspection timer is set in the ON state each time, the stack inspection is hardly executed as the stack inspection timer has a difficulty to reach the time out. In view of the above, when the stack inspection timer is set in the ON state, a stack inspection timer ON flag is set as ON. After that, even if the new monitoring target threads sequentially start operating, on the basis of the stack inspection timer ON flag, when it is determined that one of the stack inspection timer ON flags is already set as ON, the stack inspection timer is not reset in the ON state, and the timer which is originally set as the stack inspection timer in the ON state is kept operating. With this configuration, for example, in a case where the monitoring target thread A is operated, even when the monitoring target threads B, C, and D then sequentially start operating, it is possible to execute the stack inspection when the stack inspection timer set for the first time times out. Hereinafter, a description will be given of a stack inspection processing by using this method.

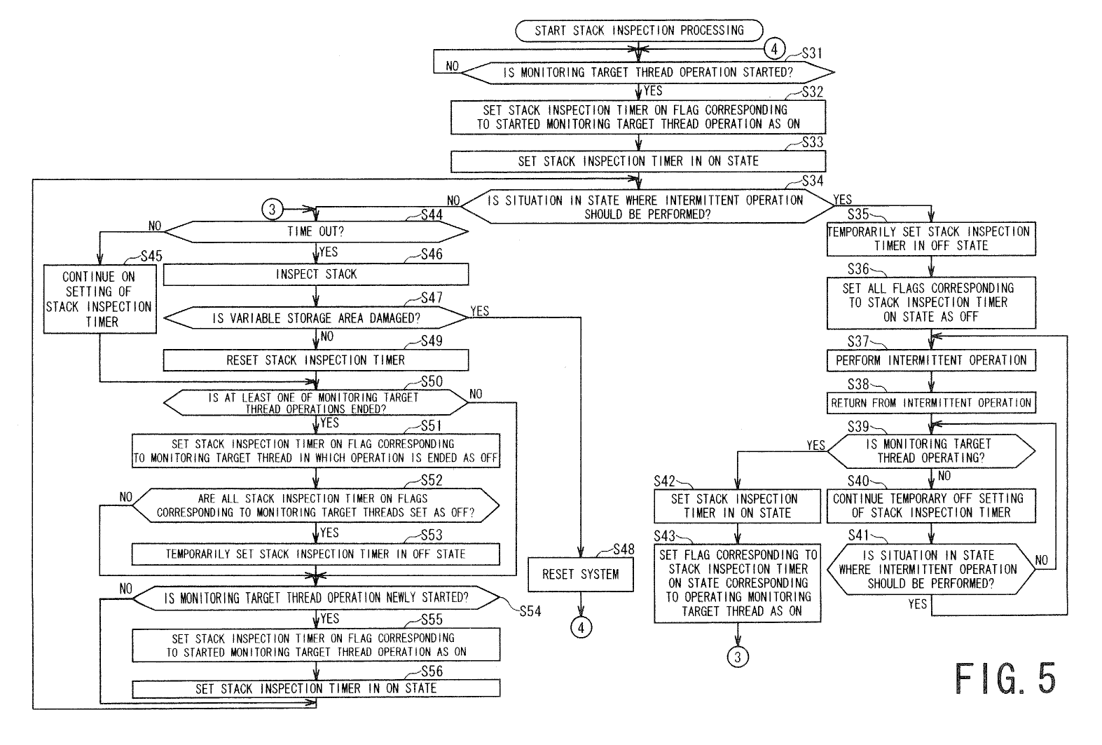

With reference to a flowchart of FIG. 5, another stack inspection processing in the cellar phone 1 of FIG. 3 will be described. It should be noted that the processing in step S31, steps S33 to S35, steps S37 to S42, steps S44 to S50, step S53 and S54, and step S56 in FIG. 5 is similar to the processing in steps S1 to S20 in FIG. 4, and a description thereof will be omitted to avoid the repetition.

In step S32, after any operation of the monitoring target threads is started, in the RAM, the CPU of the main control section 31 sets as ON, the stack inspection timer ON flag corresponding to the monitoring target thread which has started operating (for example, the monitoring target thread A or the like) (the flag is set up). That is, for example, the state of the stack inspection timer ON is stored in a register or the like of the RAM, which is not shown. It should be noted that in the RAM, the stack inspection timer ON flags corresponding to the monitoring target threads respectively exists, and each time the operation of the monitoring target thread is started, the stack inspection timer ON flag corresponding to the monitoring target thread is set as ON. After that, the processing is advanced to step S33. In step S33, the stack inspection timer is set in the ON state, and the time keeping processing is started.

In step S36, when the current situation is in the state where the intermittent operation should be performed and the stack, inspection timer is temporarily set in the OFF state, in the RAM, the CPU of the main control section 31 sets all the stack inspection timer ON flags corresponding to the respective monitoring target threads (for example, the monitoring target threads A, B, C, and the like) as OFF (the flag is set up).

In step S43, after the stack inspection time is set in the ON state, in the RAM, the CPU of the main control section 31 sets the stack inspection timer ON flag corresponding to the monitoring target thread in operation (for example, the monitoring target thread A, etc.) to be switched from OFF to ON (the flag is set up). That is, the state of stack inspection timer ON is stored, for example, in the register or the like of the RAM, which is not shown. After that, the processing is advanced to step S44.

In step S50, in a case where it is determined that at least of the operations of the monitoring target threads in which the operations have been started is ended, in step S51, the main control section 31 sets as OFF, the stack inspection timer ON flag corresponding to the monitoring target thread in which the operation is ended (for example, the monitoring target thread A or the like) in the RAM (the flag is set up). It should be noted that in a case where a plurality of the operating monitoring target threads are simultaneously ended or sequentially ended, the stack inspection timers ON flags corresponding to the plurality of the operating monitoring target threads (for example, the monitoring target thread A or the like) are respectively set to be switched from OFF to ON (the flag is set up). On the other hand, in step S50, in a case where it is determined that none of the operation of the monitoring target thread in which the operation has been started is ended, the processing in steps S51 to S53 is skipped.

In step S52, the CPU of the main control section 31 determines whether among the stack inspection timer ON flags existing in the RAM, all the stack inspection timers ON flags corresponding to the monitoring target threads are set as OFF. In step S52, in a case where it is determined that among the stack inspection timer ON flags existing in the RAM, all the stack inspection timer ON flags corresponding to the monitoring target threads are set as OFF, the processing is advanced to step S53. In step S53, the stack inspection timer is temporarily set in the OFF state.

On the other hand, in step S52, in a case where it is determined that among the stack inspection timer ON flags existing in the RAM, all the stack inspection timer ON flags corresponding to the monitoring target threads are not set as OFF and the stack inspection timer ON flag corresponding to any of the monitoring target threads is set as OK, and the processing in step S53 is skipped. That is, in a case where the stack inspection timer ON flag corresponding to any of the monitoring target threads is set as ON, the stack inspection timer is not temporarily set in the OFF state, and the ON setting of the stack inspection timer is continued.

In step S54, in a case where it is determined that the operation of the monitoring target thread is not newly started, the CPU of the main control section 31 sets the stack inspection timer ON flag corresponding to the monitoring target thread which has started operating as ON in step S55. After that, in the processing in step S56, the built-in timer is used to set the stack inspection timer to be switched from the OFF state to the ON state. With this configuration, the time keeping processing of the stack inspection timer is started. On the other hand, in step S54, in a case where it is determined that the operation of the monitoring target thread is not newly started, the processing in steps S55 and S56 is skipped. With this configuration, for example, in a case where the monitoring target thread A is operated, even when the monitoring target threads B, C, and D then sequentially start operating, it is possible to execute the stack inspection when the stack inspection timer set for the first time times out. Therefore, while the number of inspection performed on the stack used as the variable storage area is reduced, the use efficiency of the CPU is improved, and the stack used as the variable storage area can be inspected in the necessary minimum manner. In addition, the stack used as the variable storage area can he inspected at a given interval with certainty. Even if a problem is caused, the problem is promptly detected and it is possible to prevent the situation from being transited to the critical situation in which the content is damaged, etc.

It should be noted that the present invention can also be applied to, in addition to the cellar phone 1, a PDA (Personal Digital Assistant), a personal computer, a portable game machine, a portable music player, a portable video player, and other information processing apparatuses.

In addition, the series of the processing described according to the embodiment of the present invention can be executed by using software but also be executed by using hardware.

Furthermore, according to the embodiment of the present invention, such a processing example has been described that the steps of the flowcharts are processed in a time series manner in the stated order, but the present invention also encompasses a case in which the steps are not necessarily processed in the time series manner and the steps are processed in a parallel manner or individually processed.

What is claimed is:

1. An information processing apparatus, comprising:
an intermittent operation execution control unit configured to control an execution of an intermittent operation in the information processing apparatus;
a timer setting unit configured to set a timer for a stack inspection in a first state if the information processing apparatus returns from; the intermittent operation in accordance with a control of the intermittent operation execution control unit; and
a stack inspection execution unit configured to execute the stack inspection each time the timer for the stack inspection set by the timer setting unit times out.

2. The information processing apparatus according to claim 1, further comprising:
a system control unit configured to return a system to an original state in a case where it is determined as a result of the stack inspection executed by the stack inspection execution unit that a variable storage area in the stack is damaged.

3. The information processing apparatus according to claim 1, wherein in a case where the intermittent operation is executed in the information processing apparatus by the intermittent operation execution control unit, the timer setting unit sets the timer for the stack inspection in a second state.

4. The information processing apparatus according to claim 3, further comprising:
a first determination unit configured to determine whether a thread in which the stack inspection can be executed is operated in accordance with the control of the intermittent operation execution control unit if the information processing apparatus returns from the intermittent operation,
wherein in a case where the first determination unit determines that the thread in which the stack inspection can be executed is operated, the timer setting unit sets the timer for the stack inspection to be switched from the second state to the first state.

5. The information processing apparatus according to claim 4, wherein in a case where the first determination unit determines that the thread in which the stack inspection can be executed is not operated, the timer setting unit keeps the setting of the second state in the timer for the stack inspection.

6. The information processing apparatus according to claim 4, further comprising:
a second determination unit configured to determine, in a case where the first determination unit determines that the thread in which the stack inspection can be executed is operated, after the timer setting unit sets the timer for the stack inspection to be switched from the second state to the first state, whether the thread in which the stack inspection can be executed is ended,
wherein in a case where the second determination unit determines, after the timer setting unit sets the timer for the stack inspection to be switched from the second state to the first state, that the thread in which the stack inspection can be executed is ended, the timer setting unit sets the timer for the stack inspection to be switched from the first state to the second state.

7. The information processing apparatus according to claim 4, wherein in a case where the first determination unit determines that the thread in which the stack inspection can be executed is newly operated, the timer setting unit sets the timer for the stack inspection to be switched from the second state to the first state.

8. The information processing apparatus according to claim 1, further comprising:
a flag setting unit configured to set, if the timer setting unit sets the timer for the stack inspection in the first state or the second state, a flag indicating that the timer for the stack inspection is set in the first state or the second state,
wherein in a case where the timer setting unit sets the timer for the stack inspection in the first state, if all the flags set by the flag setting unit are set as the flags indicating that the timer for the stack inspection is set in the second state, the timer setting unit sets the timer for the stack inspection in the second state.
